(19) United States
(12) Patent Application Publication
(10) Pub. No.: US 2004/0174710 A1
(43) Pub. Date: Sep. 9, 2004

(54) Illumination device using micro-textured sheet

(76) Inventor: Evan Gappelberg, New York, NY (US)

Correspondence Address: Steven Horowitz, Counselor at Law, Suite 700, 295 Madison Avenue, New York, NY, 10071, US

(21) Appl. No.: 10/384,119

(22) Filed: Mar. 7, 2003

(51) Int. Cl. F21V 5/02

(52) U.S. Cl. 362/337; 362/339; 362/328

(57) ABSTRACT

An illumination device having an elongated transparent cylinder has one cylinder end covered by a housing containing an LED. A micro-textured orange or red polyvinyl chloride sheet is rolled inside the cylinder to maximize illumination at a range of external locations. The surface of the plastic seen by the unaided eye is a smooth surface and a textured surface. The textured surface faces inside the cylinder and is micro-textured according to a geometric pattern. A brickwork pattern of 4 millimeter squares is visible, wherein every third square in a row scatters light in the same way. The surface of each square is shaped by three sets of excised parallel grooves which meet in a common set of intersections at the center-lines thereof to form a lattice defining isosceles triangles. The upper sides of the grooves meet at apices within each triangle to form irregular tetrahedra on each respective triangular base.

The present invention relates to illumination devices and more particularly to such devices wherein a surface of a sheet of material is microtextured to provide enhanced illumination at a location external to the device.

### BACKGROUND OF THE INVENTION AND DESCRIPTION OF THE PRIOR ART

Illumination devices wherein light emanates from a cylindrical element adjacent a light emitting diode are well known. Also well known is microtexturing a plastic to affect the illumination process. To Applicant's knowledge, however, the present invention which uses a particular micropattern to maximize illumination of a cylindrical illumination device is not known.

### SUMMARY OF THE PRESENT INVENTION

The present invention is an illumination device that has an elongated transparent cylinder featuring one cylinder end covered by a housing containing a light emitting diode (LED), a second cylinder end preferably covered by a reflective disk and a cylinder side. A micro-textured orange or red polyvinyl chloride sheet is rolled inside the cylinder to maximize illumination at a range of external locations. The surface of the plastic seen by the unaided eye is a smooth surface on one side and a textured surface on the other side. The textured surface faces inside the cylinder and is micro-textured according to a geometric pattern. A brickwork pattern of four millimeter-sized squares is visible, wherein every third square in a row scatters light in the same way. The other two squares scatter light differently due to a rotation of the micropattern on their surfaces. The surface of each square has a micropattern invisible to the unaided eye that is formed by three sets of parallel grooves. Each set meets the other two sets at an angle and the three sets of grooves meet in a common set of intersections to form an array of isosceles triangles. The upper sides of the grooves meet at apices within each triangle to form irregular tetrahedra on each respective triangular base. The upper sides are prisms that optimize illumination of light out of the cylinder.

### IMPORTANT OBJECTS AND ADVANTAGES

The following important objects and advantages of the present invention are:

(1) to provide an illumination device that maximizes the amount of light from a light emitting diode of a particular size that is scattered out of the device

(2) to provide an illumination device that maximizes the light scattered out of the device by means of a microtextured sheet of plastic material inside the cylinder of the device.

(3) to provide an illumination device that has an invisible pattern of microtextured height deviations in the face of a rolled up sheet of plastic fitted into the cylinder of the device in order to optimize the scattering of light out of the device.

### BRIEF DESCRIPTION OF THE DRAWINGS

FIG. 1 shows an arrangement of squares of different array orientations on the sheet used in the present invention to create a visible brickwork pattern of squares.

FIG. 2 shows a representation of the pattern of the micro-prism array within a single square on the sheet used in the present invention.

### DETAILED DESCRIPTION OF THE PREFERRED EMBODIMENT

The apparatus will now be illustrated by reference to the accompanying drawings. The illumination device itself has been assigned reference numeral 10 and its elements have been assigned the reference numerals referred to below. The term “bright-colored” as used herein is intended to mean red, reddish, orange, orangish, yellow, yellowish, green, greenish and any hue that is in between these colors on the visible color spectrum. Furthermore, although the sheet 40 of device 10 of the present invention and hence the light emanating from device 10 are described herein as being bright-colored, it should be apparent that other colors can also be used although they would be less visible and would require differently shaped prisms. Orange, red, green and yellow are particularly visible in the dark from far distances. In addition, certain colors such as orange and red also are associated with devices used by the law enforcement authorities.

The device of the present invention starts off with the assumption that it is desirable to maximize the amount of light scattered out of an illumination device for a given size and power of light source used inside the device, for example a light emitting diode.

The device of the present invention is an illumination device 10, comprising an elongated and hollow transparent cylinder 20 that has a first cylinder end 22, a second cylinder end 24 and a side of cylinder 20 that is called the cylinder side 26. Cylinder 20 is typically although not necessarily approximately one half inch in diameter and approximately three inches long. The first cylinder end 22 is covered by a housing 30 that contains a light emitting diode 32. Housing 30 typically screws on to first cylinder end 22 although any other form of attachment may be used. Typically, the entire housing 30 is opaque and light emitted from the light emitting diode 32 is directed substantially into the first cylinder end 22 and into cylinder 20. Alternatively, the housing 30 may be reflective. The main requirement of housing 30 is that a substantial amount of light emitted from the light emitting diode 32 not be allowed to leave through housing 30. The simplest way is for housing 30 to be opaque and to be open one end so as to allow light from the light emitting diode 32 to escape into cylinder 20. Other forms of housing 30 can be imagined so as to prevent a substantial amount of light emitted from the light emitting diode 32 to leave through housing 30.

A plastic sheet 40 that is rolled up is placed inside the cylinder 20. The plastic is a flexible resin material. Preferably it is polyvinyl chloride but it can also be acrylic. The shape of the prisms have been calculated under the assumption that the sheet 40 is made of polyvinyl chloride. Since the index of refraction for acrylic is somewhat lower than that for rigid vinyl, 1.49 versus 1.54, it is apparent to one skilled in the art that in order to maintain the identical optical characteristtics the shape of the prisms would be slightly different in that the prisms would slightly less flat.

The sheet 40 is bright-colored, i.e. orange, red, green, yellow or a hue in between. Preferably, sheet 40 is translucent. The translucent polyvinyl chloride sheet 40 is placed inside the cylinder 20 so as to substantially cover an inside side wall 26a of the cylinder side 26. Sheet 40, when unrolled, should have a length approximately equal to the length of cylinder 20 and a width at least equal to the inner diameter of the cylinder 20 multiplied by π so that when sheet 40 is rolled up inside cylinder 20 the circumference of the nontextured side 40a exceeds the circumference of the inside side wall 26a. Some overlap of the sheet 40 is possible when rolled so that a second layer of thickness in the sheet may exist for a few millimeters of the sheet 40 when sheet 40 is rolled inside cylinder 20. The sheet 40 is typically, although not necessarily, approximately one hundredth of an inch thick. It need only be of sufficient thickness so that the light emitted goes through sheet 40 sufficiently to allow device 10 to be seen from significant distances and from a wide range of angles in external locations and so that the light that exits sheet 40 picks up the color of the sheet 40. If sheet 40 were too thick, moreover, then sheet 40 would occupy too much of the space in the hollow area inside cylinder 20 and not enough light produced by light emitting diode 32 would escape.

When sheet 40 is rolled up inside the cylinder 20, outer surface 40a of sheet 40 is flush against inner side wall 26a of cylinder side 26 of cylinder 20 That outer surface 40a of the sheet 40 has a smooth glass-like finish. The other side or surface of sheet 40, the inner surface 40b, has a micro-textured or micro-embossed finish. The inner surface 40b of the sheet 40 is micro-embossed with a geometric pattern of tetrahedral prisms 50 in order to maximize illumination. The geometric pattern of tetrahedral prisms 50 is substantially invisible to the naked eye.

Cylinder 20 is closed at second cylinder end 24 although that is not absolutely required. In a preferred embodiment, however, in order to further direct the light out of the cylinder 20 to a wide range of external locations, the second cylinder end 24 is substantially covered by a reflective disk 25. It is contemplated that other light directing means can be used besides a reflective disk.

Although the geometric pattern of tetrahedral prisms 50 cannot be seen by the unaided eye, it has an associated brickwork pattern of squares 60 that is visible to the unaided eye. The term “brickwork” pattern means an arrangement of squares similar to that depicted in FIG. 5. The purpose of the brickwork pattern of squares 60 is to ensure that a certain amount of light ends up leaving the cylinder 20 in a wide range of arcs so that viewers positioned at a range of external locations can see the device 10 illuminated from a distance. This result is accomplished both by the micropattern itself as well as by rotating the micropattern on the surface of the squares 60, thereby generating three orientations of light scattering. The result is further enhanced by repeating the three square 60 in a row pattern over the inner surface 40b of the microtextured sheet 40, as will be explained.

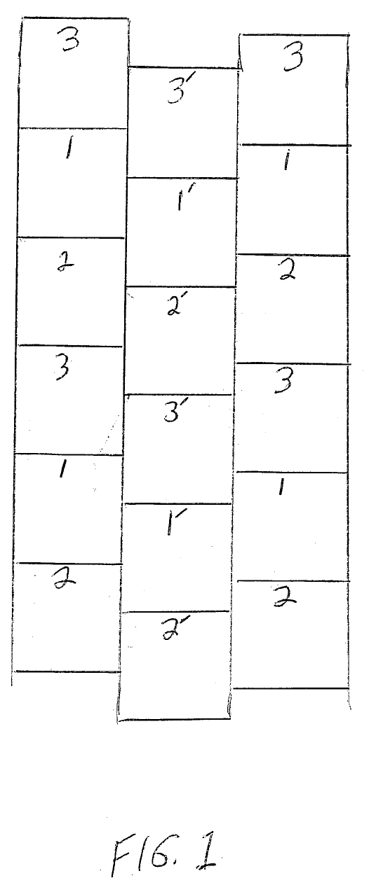

Accordingly, as seen in FIG. 1, each square 60 in the brickwork pattern scatters light in accordance with a relative degree of rotation of the micropattern. The brickwork pattern includes a repeating group of three adjacent squares 60 in a row wherein a first square 60a has a first orientation (represented by “1” in FIG. 1), a second adjacent square 60b has a second orientation (represented by “2” in FIG. 1) and a third adjacent square 60c has a third orientation (represented by “3” in FIG. 1). Each successive orientation differs by a sixty degree rotation of the micropattern on the square 60 so that every third square scatters light in the same way, there being a 180 degree symmetry in the micropattern. In an adjacent row of squares 60 the successive orientations within the row also differ by a sixty degree rotation—represented by the numbers 1′ 2′ and 3′ in FIG. 1) but they also differ by a thirty degree rotation as compared to the adjacent square in the adjacent row. This leads to orientation 1′ being thirty degrees rotationally different from orientation 1, orientation 2′ being ninety degree rotationally different from orientation 1 and orientation 3′ being 150 degree rotationally different from orientation 1. The third row across also has its successive orientations within the row differ by a sixty degree rotation and is identical to the first row of squares 60 although the first and third row may or may not be aligned (in FIG. 1 they are not) insofar as orientation “1” in each row being at the same latitude. The thirty degree rotational difference in adjacent rows of squares 60 is for the same reason as the 60 degree discrepancy in rotational alignment within a given row—to further ensure that light leaves cylinder 20 in a wide enough range of arcs so that viewers positioned at a range of external locations can see the device 10 illuminated from a distance.

Each square 60 in the brickwork pattern has sides approximately equal to four millimeters. It is contemplated by the present invention that the squares can be smaller or larger. However, if the squares 60 were too large, the brickwork pattern would not be able to repeat itself enough times and if the squares were too small, the micropattern on each square 60 would be too difficult to manufacture.

The purpose of rotating the micropattern in sets of three repeated squares 60 is to ensure that at least one-third of the array of squares is optimally or nearly optimally oriented at the correct angle needed to scatter light out of device 10 when the light emanating from light emitting diode 32 enters the tetrahedral micro-prisms on the squares 60 at a range of entry angles when device 10 is functioning as a retroreflector. It is believed that the reason such an array is effective in the present invention is that the varying orientations of arrays serve to place at least one-third of the arrays in a favorably situated position to direct light out of a cylinder 20 so that viewers situated at some range of viewing angles can see the device 10 very brightly and from approximately a 1000 foot distance.

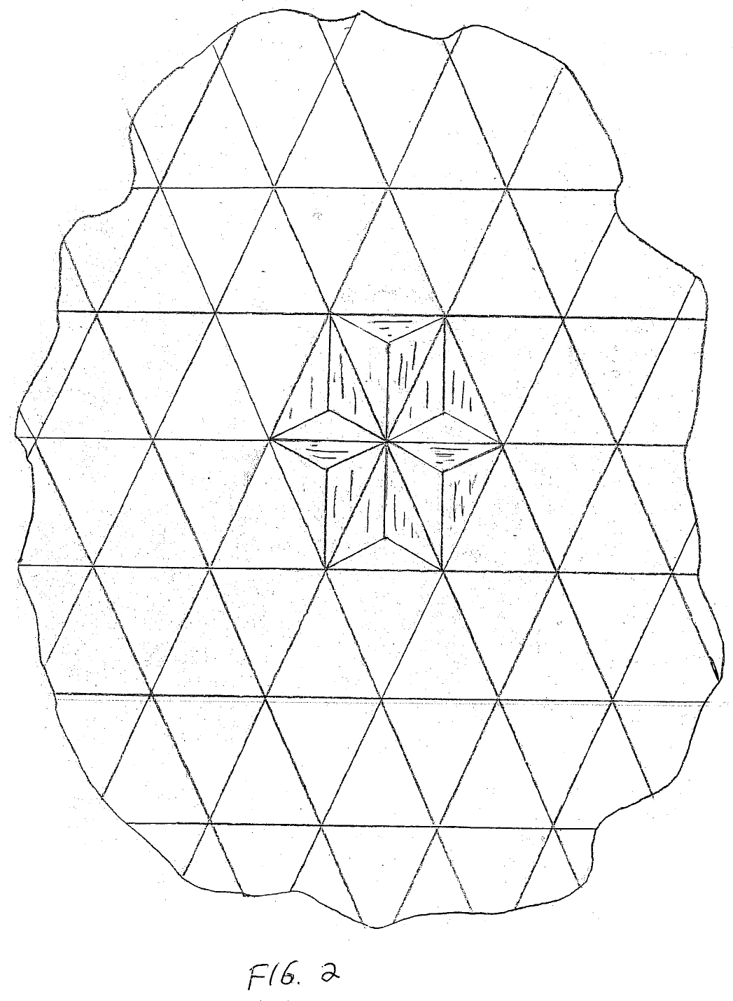

FIG. 2. shows a section of the array of micro-prisms 50 on the surface 40b. In the array, six tetrahedra or micro-prisms are shown as complete and as forming a distorted hexagon at their base. In order to demonstrate the overall pattern of the prisms 50, the sides of the bases are extended to the area beyond the six tetrahedra in FIG. 2. As may be appreciated from FIG. 2, the prisms 50 occur in two orientations. Given that there are also three faces on each prism 50, it is apparent that there are a total of two times three, or six, major “spots” in the refraction pattern.

The invisible micropattern is designed to maximize the chance that a certain amount of light ends up leaving the cylinder 20 in a wide range of arcs in order that viewers positioned at a range of external locations can see the device 10 illuminated from a distance.

Accordingly, with respect to the invisible micropattern embossed on the inner surface 40b of each square 60, a surface of each square 60 contains a substantially invisible micropattern of tetrahedrons 50 featuring three sets of linear grooves 51, 52, 53. Each set of linear grooves contains a series of parallel linear grooves (e.g. 51a, 51b, 51c, etc.). The three sets of linear grooves 51, 52, 53 are angles with one another so that no two sets coincide and there are in fact three sets, namely a first set 51, a second set 52 and a third set 53 of linear grooves. The three sets of linear grooves 51, 52, 53 meet at a single common set of intersections 55 throughout the square 60. As a result, an array of isosceles triangles 66 is formed from the grooves 51, 52, 53 and intersections 55. It should be noted that if the length of a line perpendicular to two parallel grooves 52a, 52b within a set of grooves represents the distance or the “spacing” between the grooves of that set, then if we define the grooves or lines in FIG. 2 that are positioned vertically to be the first set of grooves 51 in FIG. 2, the correct spacing for the first set of grooves 51 shown in FIG. 2 would be approximately 1/100 of an inch. It would then follow that the appropriate spacing for each of the remaining two sets of grooves, 52, 53 would be approximately 29/35 of 1/100 of an inch.

The grooves 51, 52, 53 in the micro-pattern can be manufactured by various well known techniques. A mold for the micro-pattern can be formed by outlining on the surface of the mold a pattern of microscopic grooves 51, 52, 53 having the appropriate spacing, as described above Then, in order to actually carve out the grooves 51, 52, 53 from the surface of the mold, all material is removed from the surface except the material forming the desired prisms 50.

The tetrahedra 50 on the inner surface 40b of the sheet 40 in the micro-pattern can also be viewed as cube corners. Imagine a cube whose corner was sliced off at an angle that is 45 degrees to a side of the cube. The material removed from the cube corner would itself be a tetrahedron 50. It would be a more irregular tetrahedron if the corner were sliced off at an angle different from 45 degrees.

Ideally, and as seen from FIG. 2, tetrahedra 50 of the micropattern of the present invention are also rotated so that they are tilted away from an imaginary vertical line drawn to the tetrahedron 50 from directly above the surface 40b of the sheet 40. This also serves to increase the range of observer angles from which a bright light will be seen.

As can be seen, in the present invention, an irregular tetrahedron 50 is formed on each isosceles triangle 66. The sides 58 of the tetrahedron 50 begin at a bottom of a groove 51, 52, 53 and meet at an apex 59. Ideally, the angles of each triangle 66 are approximately 65 degrees, 65 degrees and 50 degrees. These numbers for the angles are +/−one degree. However, it is contemplated that less ideal embodiments may use other angles to form other isosceles triangles within the spirit of the present invention.

The prisms are also defined by the angles of the apex 59. The three angles of the apex 59 or upper corner of the prisms 50 oriented toward the viewer are approximately 90 degrees, approximately 80.9 degrees and approximately 80.9 degrees +/−0.2 degrees. This distortion from 90 degrees down to approximately 81 degrees in two of the three angles of the apex 59 is consistent with the overall array being a distorted cube corner array such as is used in retroreflectors. The purpose of distorting the cube in retroreflectors is to slightly increase the width of the reflected beam.

The resulting illumination produces a very bright light that can be seen from a thousand feet away and that is a very appealing bright-colored light in a dark room.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. An illumination device, comprising:
an elongated transparent cylinder having a first cylinder end, a second cylinder end and a cylinder side, said first cylinder end covered by a housing containing a light emitting diode, a light emitted from the light emitting diode being directed substantially into the cylinder,
a micro-textured sheet of a bright-colored translucent plastic placed inside the cylinder to substantially cover an inside wall of the cylinder side,
said sheet having an inner surface that is micro-embossed with a geometric pattern of tetrahedral prisms in order to maximize illumination, said geometric pattern of tetrahedral prisms being substantially invisible to the naked eye, the geometric pattern of tetrahedral prisms having an associated visible brickwork pattern of squares

2. The device of claim 1, wherein the plastic is polyvinyl chloride.

3. The device of claim 2, wherein the sheet has a thickness of approximately one hundredth of an inch.

4. The device of claim 2, wherein said second cylinder end is substantially covered by a reflective disk.

5. The device of claim 2, wherein each square has sides approximately equal to four millimeters.

6. The device of claim 2, wherein in the brickwork pattern of squares every third square in a row scatters light in the same way

7. The device of claim 2, wherein a surface of each square contains a substantially invisible micropattern of tetrahedrons formed on isosceles triangles, said tetrahedrons featuring three sets of linear grooves, each set containing a series of parallel linear grooves, said three sets of linear grooves meeting at a single common set of intersections to form an array of isosceles triangles, the sides of the tetrahedrons beginning at a bottom of a groove and meeting at an apex.

8. The device of claim 7, wherein the prism is defined such that the angles of each triangle formed by an intersection of the grooves are approximately 65, approximately 65 and approximately 50 degrees.

9. The device of claim 7, wherein each square in the brickwork pattern scatters light in accordance with a relative degree of rotation of the micropattern,

10. The device of claim 9, wherein said brickwork pattern includes a repeating group of three adjacent squares in a row wherein a first square has a first orientation, a second adjacent square has a second orientation and a third adjacent square has a third orientation, each successive orientation caused by a sixty degree rotation of the micropattern so that every third square scatters light in the same way.

11. The device of claim 10, wherein the prism is defined such that the angles of each triangle formed by an intersection of the grooves are approximately 65, approximately 65 and approximately 50 degrees.

12. The device of claim 11, wherein the prism is further defined in that the angles of an apex of each prism are approximately 90 degrees, approximately 81 degrees and approximately 81 degrees.

13. The device of claim 2, wherein a surface of each square contains a substantially invisible micropattern of tetrahedrons featuring three sets of linear grooves, each set containing a series of parallel linear grooves, said three sets of linear grooves meeting at a single common set of intersections to form an array of isosceles triangles, wherein each square in the brickwork pattern scatters light in accordance with a relative degree of rotation of the micropattern, and wherein said brickwork pattern includes a repeating group of three adjacent squares in a row wherein a first square has a first orientation, a second adjacent square has a second orientation and a third adjacent square has a third orientation, each successive orientation caused by a sixty degree rotation of the micropattern so that every third square scatters light in a same way.

14. The device of claim 2, wherein the bright-colored translucent plastic is red or orange.

15. An illumination device, comprising:
an elongated transparent cylinder having a first cylinder end, a second cylinder end and a cylinder side, said first cylinder end covered by a housing containing a light emitting diode such that a light emitted from the light emitting diode is directed substantially into the cylinder,
a micro-textured sheet of a bright-colored translucent polyvinyl chloride placed inside the cylinder to substantially cover an inside wall of the cylinder side,
said sheet having an inner surface that is micro-embossed with a geometric pattern of tetrahedral prisms in order to maximize illumination, said geometric pattern of tetrahedral prisms being substantially invisible to the naked eye, an apex of each tetrahedral prism having angles of approximately 90 degrees, approximately 81 degrees and approximately 81 degrees.

16. An illumination device, comprising:
an elongated transparent cylinder having a first cylinder end, a second cylinder end and a cylinder side, said first cylinder end covered by a housing containing a light emitting diode, a light emitted from the light emitting diode being directed substantially into the cylinder,
a micro-textured sheet of a bright-colored translucent acrylic plastic placed inside the cylinder to substantially cover an inside wall of the cylinder side,
said sheet having an inner surface that is micro-embossed with a geometric pattern of tetrahedral prisms in order to maximize illumination, said geometric pattern of tetrahedral prisms being substantially invisible to the naked eye, the geometric pattern of tetrahedral prisms having an associated visible brickwork pattern of squares

17. The device of claim 16, wherein the sheet has a thickness of approximately one hundredth of an inch.

18. The device of claim 16, wherein said second cylinder end is substantially covered by a reflective disk.

19. The device of claim 16, wherein in the brickwork pattern of squares every third square in a row scatters light in the same way

20. The device of claim 16, wherein a surface of each square contains a substantially invisible micropattern of tetrahedrons formed on isosceles triangles, said tetrahedrons featuring three sets of linear grooves, each set containing a series of parallel linear grooves, said three sets of linear grooves meeting at a single common set of intersections to form an array of isosceles triangles, the sides of the tetrahedrons beginning at a bottom of a groove and meeting at an apex.

21. The device of claim 20, wherein each square in the brickwork pattern scatters light in accordance with a relative degree of rotation of the micropattern,

22. The device of claim 20, wherein said brickwork pattern includes a repeating group of three adjacent squares in a row wherein a first square has a first orientation, a second adjacent square has a second orientation and a third adjacent square has a third orientation, each successive orientation caused by a sixty degree rotation of the micropattern so that every third square scatters light in the same way.

23. The device of claim 17, wherein the bright-colored translucent plastic is red or orange.
